(19) United States
(12) Patent Application Publication
(10) Pub. No.: US 2016/0019168 A1
(43) Pub. Date: Jan. 21, 2016

(54) On-Demand Shareability Conversion In A Heterogeneous Shared Virtual Memory

(71) Applicant: QUALCOMM Incorporated, San Diego, CA (US)

(72) Inventors: Bohuslav Rychlik, San Diego, CA (US); Jason Edward Podaima, Toronto (CA); Andrew Evan Gruber, Arlington, MA (US); Tzung Ren Tzeng, San Jose, CA (US); Zhenbiao Ma, Fremont, CA (US)

(21) Appl. No.: 14/510,804

(22) Filed: Oct. 9, 2014

Related U.S. Application Data
(60) Provisional application No. 62/026,319, filed on Jul. 18, 2014.

(51) Int. Cl. G06F 12/14; G06F 3/06

(52) U.S. Cl. CPC G06F 12/1483; G06F 3/0622; G06F 3/0637; G06F 3/067; G06F 2212/152

(57) ABSTRACT

The aspects include systems and methods of managing virtual memory page shareability. A processor or memory management unit may set in a page table an indication that a virtual memory page is not shareable with an outer domain processor. The processor or memory management unit may monitor for when the outer domain processor attempts or has attempted to access the virtual memory page. In response to the outer domain processor attempting to access the virtual memory page, the processor may perform a virtual memory page operation on the virtual memory page.

### RELATED APPLICATIONS

This application claims the benefit of priority to U.S. Provisional Application No. 62/026,319 entitled “On-Demand Shareability Conversion In A Heterogeneous Shared Virtual Memory” filed Jul. 18, 2014, the entire contents of which are hereby incorporated by reference.

### BACKGROUND

In a heterogeneous shared architecture (HSA), shared virtual memory (SVM) is an approach to memory management that allows more than one processor to access a virtual memory location. Using shared virtual memory, a single-process virtual address space from an application running on one processor, such as a central processor unit (CPU), may be shared across other threads or kernels running on another processor, such as a graphics processor unit (GPU) or a digital signal processor (DSP). The various processors may share a single page table for each application for virtual-to-physical address translation, which is a more efficient approach than replicating the page table for each processor.

In full memory shared virtual memory, at the time that memory is allocated to a thread or kernel it is not possible to determine whether data will be shared with more than one processor. This may result in all user application memory being marked as sharable for heterogeneous computing. To maintain memory coherency, memory marked sharable is associated with snoop activity, which increases as the amount of memory marked as sharable increases. However, marking all user memory as sharable is inefficient, as in practice a much smaller amount of memory is actually shared among threads.

### SUMMARY

The various aspects include methods that improve the performance and functioning of computing devices by better managing virtual memory page shareability, which may include setting in a page table an indication that a virtual memory page is not shareable with an outer domain processor, monitoring for an attempt by the outer domain processor to access the virtual memory page; and performing an operation in response to an attempt by the outer domain processor to access the virtual memory page. In an aspect, performing an operation in response to an attempt by the outer domain processor to access the virtual memory page may include performing a virtual memory page operation on the virtual memory page. In a further aspect, performing a virtual memory page operation on the virtual memory page may include changing the indication in the page table to indicate that the virtual memory page is shareable with the outer domain processor.

In an aspect, setting in a page table an indication that a virtual memory page is not shareable with an outer domain processor may include setting in an existing page table field of the page table the indication that the virtual memory page is not shareable with the outer domain processor, and changing the indication in the page table to indicate that the virtual memory page is shareable with the outer domain processor may include changing the indication in the existing page table field of the page table. In an aspect, setting in an existing page table field of the page table the indication that the virtual memory page is not shareable with the outer domain processor may include setting at least one existing bit in the page table field of the page table indicating that the virtual memory page is not shareable with the outer domain processor, and changing the indication in the existing page table field of the page table may include changing the at least one existing bit of the page table field of the page table indicating that the virtual memory page is shareable with the outer domain processor.

In a further aspect, the methods may include generating an interrupt in response to an attempt by the outer domain processor to access the virtual memory page, in which changing the indication in the page table to indicate that the virtual memory page is shareable with the outer domain processor may include changing the indication in the page table based on the interrupt. In an aspect, performing a virtual memory page operation on the virtual memory page may include determining an access permission for the virtual memory page to indicate whether the outer domain processor may access the virtual memory page.

In a further aspect, the methods may include generating an interrupt in response to an attempt by the outer domain processor to access the virtual memory page, in which determining the access permission for the virtual memory page to indicate whether the outer domain processor may access the virtual memory page is based on the interrupt. In an aspect, determining the access permission for the virtual memory page may further include at least one of converting the interrupt into a permissions violation, stopping an instruction executing on the outer domain processor, and changing the access permission of the virtual memory page. In an aspect, performing a virtual memory page operation on the virtual memory page may include generating debugging information for the virtual memory page based on the attempted access to the virtual memory page.

In an aspect, performing a virtual memory page operation on the virtual memory page may include performing a management operation for the virtual memory page based on the attempted access to the virtual memory page, which may include at least one of determining whether to pin the virtual memory page, and determining whether to move the virtual memory page to a memory location of a different access rate. In an aspect, performing an operation in response to an attempt by the outer domain processor to access the virtual memory page may include triggering a page fault in response to an attempt by the outer domain processor to access the virtual memory page.

In an aspect, performing an operation in response to an attempt by the outer domain processor to access the virtual memory page may include stalling a memory management unit from continuing to process a memory operation, stalling at least a portion of the outer domain processor, causing the outer domain processor to perform a context switch operation, and/or causing a memory management unit to generate further data responses to the outer domain processor with a specific policy. In an aspect, the specific policy may include one of returning zero values for reads, and ignoring writes. In a further aspect, the methods may notify a host processor about the page fault. In some aspects, notifying the host processor may include triggering an interrupt to a host OS processor, writing a value in memory, and/or writing a value in a register.

Further aspects include a computing device that includes means for performing functions of the operations of the aspect methods described above. Further aspects include a computing device having a processor configured with processor-executable instructions to perform operations of the aspect methods described above. Further aspects include a non-transitory processor-readable storage medium having stored thereon processor-executable software instructions configured to cause a processor to perform operations of the aspect methods described above.

### BRIEF DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the invention, and not to limit the disclosed aspects.

FIG. 1 is a component block diagram illustrating an example system-on-chip (SOC) architecture that may be used in computing devices implementing the various aspects.

FIG. 2 is a function block diagram illustrating an example multicore processor architecture that may be used to implement the various aspects.

FIG. 3 is a function block diagram illustrating an example shared virtual memory system.

FIG. 4 is a process flow diagram illustrating an aspect method of managing virtual memory page shareability.

FIG. 5 is a process flow diagram illustrating another aspect method of managing virtual memory page shareability.

FIG. 6A is a process flow diagram illustrating another aspect method of managing virtual memory page shareability.

FIG. 6B is a process flow diagram illustrating another aspect method of managing virtual memory page shareability.

FIG. 7 is a component block diagram of an example mobile device suitable for use with the various aspects.

FIG. 8 is a component block diagram of an example server suitable for use with various aspects.

FIG. 9 is a component block diagram of an example laptop computer suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

The word “exemplary” is used herein to mean “serving as an example, instance, or illustration.” Any implementation described herein as “exemplary” is not necessarily to be construed as preferred or advantageous over other implementations.

The terms “mobile device,” and “computing device” are used interchangeably herein to refer to any one or all of cellular telephones, smartphones, personal or mobile multi-media players, personal data assistants (PDAs), laptop computers, tablet computers, smartbooks, palmtop computers, wireless electronic mail receivers, multimedia Internet enabled cellular telephones, wireless gaming controllers, and similar electronic devices that include a programmable processor and a memory. While the various aspects are particularly useful in mobile devices, such as cellular telephones and other portable computing platforms, which may have relatively limited processing power and/or power storage capacity, the aspects are generally useful in any computing device that allocates threads, processes, or other sequences of instructions to a processing device or processing core.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “multicore processor” is used herein to refer to a single integrated circuit (IC) chip or chip package that contains two or more independent processing devices or processing cores (e.g., CPU cores) configured to read and execute program instructions. A SOC may include multiple multicore processors, and each processor in an SOC may be referred to as a “core” or a “processing core.” The term “multiprocessor” is used herein to refer to a system or device that includes two or more processing units configured to read and execute program instructions. The term “process” is used herein to refer to a sequence of instructions, which may be executed on a processor.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

To keep pace with increased consumer demands, mobile devices have become more feature-rich, and now commonly include multiple processing devices, multi-core processors, system-on-chips (SOCs), and other resources that allow mobile device users to execute complex software applications (e.g., video and audio streaming and/or processing applications, network gaming applications, etc.) on mobile devices. The execution of complex software applications is increasingly performed using multithreaded processing techniques in a heterogeneous shared architecture (HSA). Shared virtual memory (also referred to as SVM) enables more than one processing device to access a single virtual memory space shared among a number of processing devices. For example, a single-process virtual address space from an application running on one processor, such as a CPU, may be shared across other threads or kernels running on another processor, such as a GPU or DSP. The various processors within a computing device may share a single page table for each application for virtual-to-physical address translation, for increased efficiency and much easier software management over replicating the page table for each processor.

In full memory shared virtual memory it typically is not possible to determine in advance whether data will be shared with more than one processor at the time that memory is allocated to a thread or kernel. This may result in all user application memory being marked as sharable for heterogeneous computing. Memory that may be shared among processors is associated with a coherency overhead, such as snooping or other coherency operations, which may increase as the amount of memory marked as sharable increases. Marking all user memory as sharable is inefficient, since in practice a much smaller amount of memory is actually shared among threads.

Previous possible solutions to the inefficient allocation of shared virtual memory have required additional fields in a page table, making the changed page table inconsistent with standardized chip architectures. Such possible solutions have also required the operating system to handle any failures to locate memory address translations, such as translation lookaside buffer (TLB) misses, unnecessarily consuming processor resources to determine the memory address translation (e.g., a page walk process). Further, the requirement of additional information, such as additional metadata or an additional data structure, slows down decision making and access speed to the virtual memory location in question.

The various aspects improve the functioning of a computing device by provide systems and methods of managing virtual memory page shareability. In some aspects, an indication may be set in a page table that a virtual memory page is not shareable with an outer domain processor. It may be determined that the outer domain processor attempts to access the virtual memory page, and based on the determination, performing a virtual memory page operation may be performed on the virtual memory page. In some aspects, an indication may be set in the page table that each of a plurality of virtual memory pages is not shareable with the outer domain processor. The indication may be set for substantially all virtual memory pages represented in the page table.

In some aspects, an interrupt may be generated when an outer domain processor attempts to access a virtual memory page for which an indication is set that the virtual memory page is not shareable with the outer domain processor. For example, based on an attempt by the outer domain processor to access the virtual memory page, a memory management unit (MMU) or a system memory management unit (SMMU) may determine that the page table (e.g., the page table field) includes an indication that the virtual memory page is not outer shareable. In some aspects, the MMU may be integrated into a processor. In some aspects, the SMMU may be external to a processor. The MMU and/or SMMU may be provided in a variety of other configurations. The MMU and SMMU may be referred to generally as a memory management unit. In response to such a determination of the page table entry, the MMU or SMMU may generate an interrupt, and the MMU or SMMU of the outer domain processor may cause (e.g., trigger) a page fault on the outer domain processor. In such a case, the outer domain processor may stall, or the outer domain processor may switch contexts to another process or thread. In some aspects, the stall of the outer domain processor may occur directly in response to the page fault. Alternatively, the SMMU or MMU may indirectly cause the stall of the outer domain processor by stalling a transaction causing the page fault, which may increase congestion of transaction pipeline(s) and/or queue(s) between and within the outer domain processor and the SMMU or MMU. The MMU or SMMU may also send the interrupt to a host operating system processor, for example, to notify the host operating system processor about the page fault. In response to receiving the interrupt, the host operating system processor may trigger an interrupt handler or interrupt service routine. One or more virtual memory page operations may then be performed on the virtual memory page.

In some aspects, the virtual memory page operation may include changing the page table indication to share the virtual memory page with the outer domain processor. For example, setting in the page table the indication may further include setting in an existing page table field of the page table the indication that the virtual memory page is not shareable with the outer domain processor, and changing in the existing page table field of the page table the indication to share the virtual memory page with the outer domain processor. In some aspects, at least one existing bit in the page table field of the page table may indicate that the virtual memory page is, or is not, shareable with the outer domain processor. To change the indication of shareability, the at least one existing bit of the page table field of the page table may be changed to share the virtual memory page with the outer domain processor. As described above, in some aspects an interrupt may be generated when it is determined that the outer domain processor attempts to access the virtual memory page. In response to such a determination, the page table indication may be changed to share the virtual memory page with the outer domain processor based on the interrupt.

Alternatively or additionally, in some aspects the virtual memory page operation may include determining an access permission for the virtual memory page to indicate whether the outer domain processor may access the virtual memory page. In some aspects, an interrupt may be generated when it is determined that the outer domain processor attempts to access the virtual memory page, and the access permission for the virtual memory page may be determined based on the interrupt, to indicate whether the outer domain processor may access the virtual memory page.

In alternative or additional aspects, based on the attempted access to the virtual memory page, debugging information may be generated for the virtual memory page. Additionally or alternatively, a management operation may be performed for the virtual memory page based on the attempted access to the virtual memory page. Examples of a management operation for the virtual memory page include determining whether to pin the virtual memory page, and determining whether to move the virtual memory page to a memory location of a different access rate.

In alternative or additional aspects, the virtual memory page operation may include causing the MMU or SMMU to generate further data responses to the outer domain processor with a specific policy. The specific policy may include returning zero values for reads, and ignoring writes (also known as read-as-zero, write-ignore or RAZ/WI).

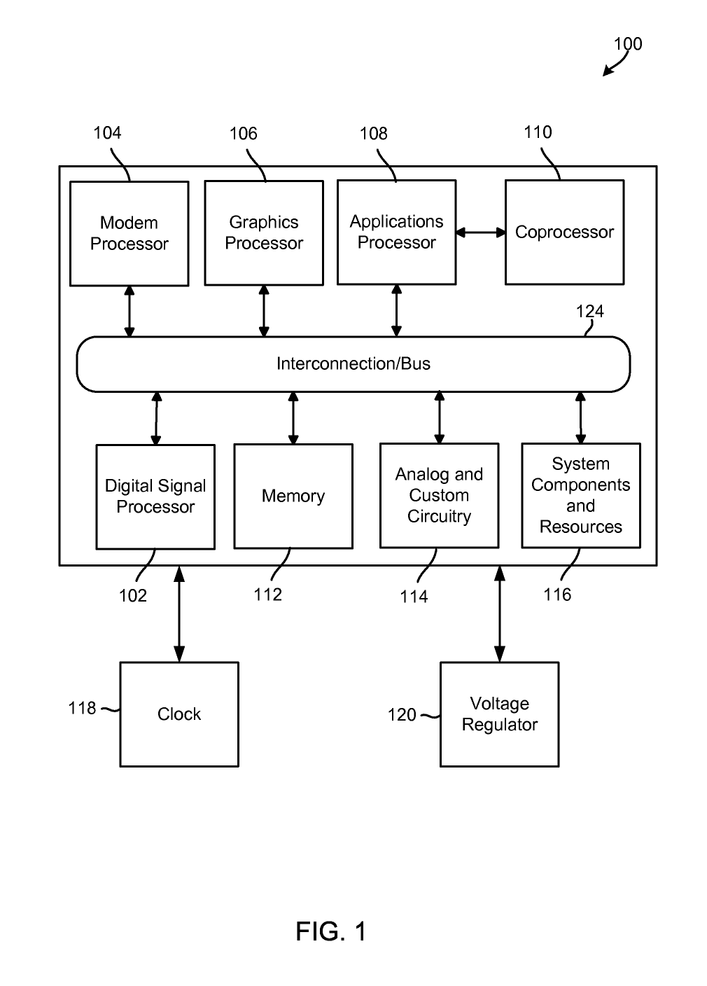

The various aspects may be implemented on a number of single processor and multiprocessor computer systems, including a system-on-chip (SOC). FIG. 1 illustrates an example system-on-chip (SOC) 100 architecture that may be used in computing devices implementing the various aspects. The SOC 100 may include a number of heterogeneous processors, such as a digital signal processor (DSP) 102, a modem processor 104, a graphics processor 106, and an application processor 108. The SOC 100 may also include one or more coprocessors 110 (e.g., vector co-processor) connected to one or more of the heterogeneous processors 102, 104, 106, 108. Each processor 102, 104, 106, 108, 110 may include one or more cores (e.g., processing cores (not illustrated), and each processor/core may perform operations independent of the other processors/cores. SOC 100 may include a processor that executes an operating system (e.g., FreeBSD, LINUX, OS X, Microsoft Windows 8, etc.) comprising a scheduler configured to schedule sequences of instructions, such as threads, processes, or data flows, to one or more processing cores for execution.

The SOC 100 may also include analog circuitry and custom circuitry 114 for managing sensor data, analog-to-digital conversions, wireless data transmissions, and for performing other specialized operations, such as processing encoded audio and video signals for rendering in a web browser. The SOC 100 may further include system components and resources 116, such as voltage regulators, oscillators, phase-locked loops, peripheral bridges, data controllers, memory controllers, system controllers, access ports, timers, and other similar components used to support the processors and software programs running on a computing device.

The system components and resources 116 and/or custom circuitry 114 may include circuitry to interface with peripheral devices, such as cameras, electronic displays, wireless communication devices, external memory chips, etc. The processors 102, 104, 106, 108 may communicate with each other, as well as with one or more memory elements 112, system components and resources 116, and custom circuitry 114, via an interconnection/bus module 124, which may include an array of reconfigurable logic gates and/or implement a bus architecture (e.g., CoreConnect, AMBA, etc.). Communications may be provided by advanced interconnects, such as high performance networks-on chip (NoCs).

The SOC 100 may further include an input/output module (not illustrated) for communicating with resources external to the SOC, such as a clock 118 and a voltage regulator 120. Resources external to the SOC (e.g., clock 118, voltage regulator 120) may be shared by two or more of the internal SOC processors/cores (e.g., a DSP 102, a modem processor 104, a graphics processor 106, an application processor 108, etc.).

In addition to the SOC 100 discussed above, the various aspects may be implemented in a wide variety of computing systems, which may include multiple processors, multicore processors, or any combination thereof.

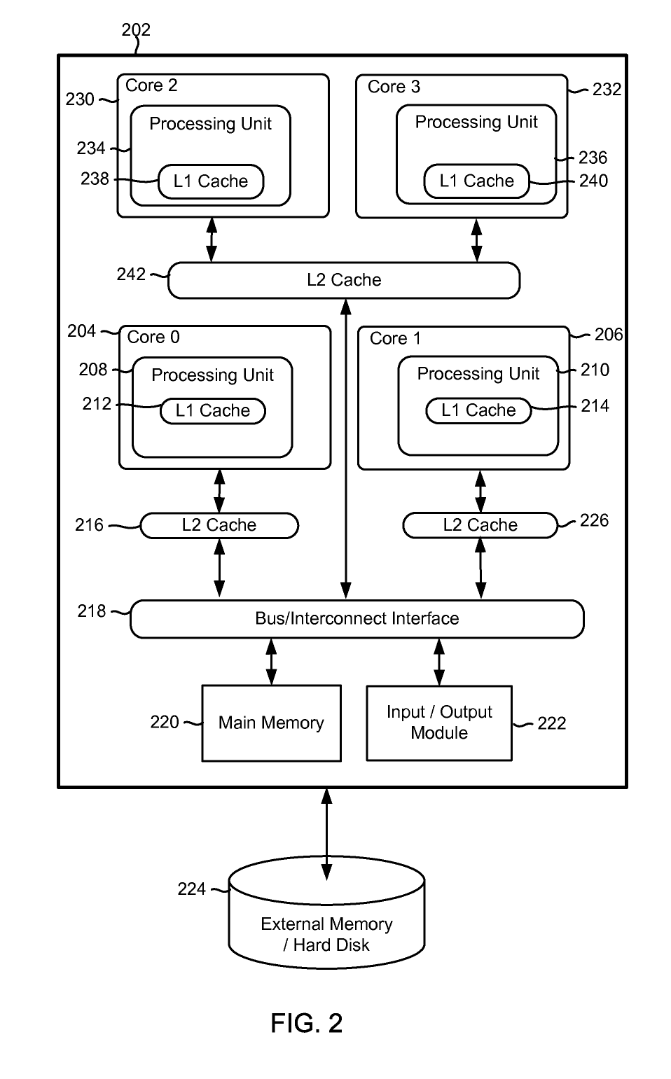

FIG. 2 illustrates an example multicore processor architecture that may be used to implement the various aspects. The multicore processor 202 may include two or more independent processing cores 204, 206, 230, 232 in close proximity (e.g., on a single substrate, die, integrated chip, etc.). The proximity of the processing cores 204, 206, 230, 232 allows memory to operate at a much higher frequency/clock-rate than is possible if the signals have to travel off-chip. The proximity of the processing cores 204, 206, 230, 232 allows for the sharing of on-chip memory and resources (e.g., voltage rail), as well as for more coordinated cooperation between cores. While four processing cores are illustrated in FIG. 2, it will be appreciated that this is not a limitation, and a multicore processor may include more or fewer processing cores.

The multicore processor 202 may include a multi-level cache that includes Level 1 (L1) caches 212, 214, 238, and 240 and Level 2 (L2) caches 216, 226, and 242. The multicore processor 202 may also include a bus/interconnect interface 218, a main memory 220, and an input/output module 222. The L2 caches 216, 226, 242 may be larger (and slower) than the L1 caches 212, 214, 238, 240, but smaller (and substantially faster) than a main memory unit 220. Each processing core 204, 206, 230, 232 may include a processing unit 208, 210, 234, 236 that has private access to an L1 cache 212, 214, 238, 240. The processing cores 204, 206, 230, 232 may share access to an L2 cache (e.g., L2 cache 242) or may have access to an independent L2 cache (e.g., L2 cache 216, 226).

The L1 and L2 caches may be used to store data frequently accessed by the processing units, whereas the main memory 220 may be used to store larger files and data units being accessed by the processing cores 204, 206, 230, 232. The multicore processor 202 may be configured so that the processing cores 204, 206, 230, 232 seek data from memory in order, first querying the L1 cache, then L2 cache, and then the main memory if the information is not stored in the caches. If the information is not stored in the caches or the main memory 220, multicore processor 202 may seek information from an external memory and/or a hard disk memory 224.

The processing cores 204, 206, 230, 232 may communicate with each other via the bus/interconnect interface 218. Each processing core 204, 206, 230, 232 may have exclusive control over some resources and share other resources with the other cores.

The processing cores 204, 206, 230, 232 may be identical to one another, be heterogeneous, and/or implement different specialized functions. Thus, processing cores 204, 206, 230, 232 need not be symmetric, either from the operating system perspective (e.g., may execute different operating systems) or from the hardware perspective (e.g., may implement different instruction sets/architectures).

Multiprocessor hardware designs, such as those discussed above with reference to FIGS. 1 and 2, may include multiple processing cores of different capabilities inside the same package, often on the same piece of silicon. Symmetric multiprocessing hardware includes two or more identical processors connected to a single shared main memory that are controlled by a single operating system. Asymmetric or “loosely-coupled” multiprocessing hardware may include two or more heterogeneous processors/cores that may each be controlled by an independent operating system and connected to one or more shared memories/resources.

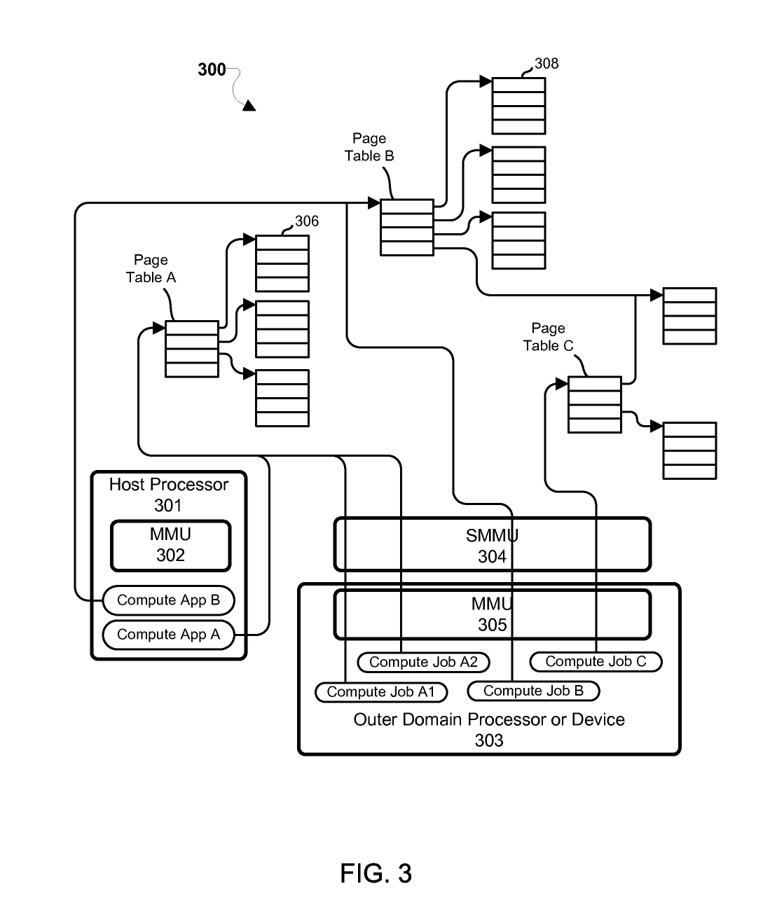

FIG. 3 is a function block diagram 300 illustrating an example shared virtual memory system. A host processor 301 and an outer domain processor or device 303 may include the multicore processor architecture illustrated in FIG. 2. The host processor 301 may include a memory management unit (MMU) 302, and the outer domain processor 303 may include an MMU 305. Additionally, a system memory management unit (SMMU) 304 may be implemented as a standalone device, or it may be integrated with a processor, such as the outer domain processor 303. Thus, a system may include either an integrated MMU 305, or an SMMU 304, or both. Applications may be executed on the host processor 301 and/or the outer domain processor 303. In some aspects, the host processor may also include a host operating system (OS) processor.

In some aspects, the MMU 302 may be implemented as part of a CPU, or it may be implemented as a separate hardware device, such as a separate integrated circuit. In some aspects, the MMU 305 may be included in the outer domain processor 303, and the SMMU 304 may be implemented external to the outer domain processor. The MMUs 302 and 305 may perform virtual memory management operations, including address translation between virtual memory and physical memory addresses, as well as other management functions including memory protection, cache control, and communication bus arbitration. Similar to the MMUs 302 and 305, the SMMU 304 may perform virtual memory management operations including address translation between virtual memory and physical memory addresses. A memory mapping manager or similar operation may be implemented for each of the MMU 302, the MMU 305, and the SMMU 304 to manage address mapping and coherency processes among various processing devices.

In operation, the MMU 302 may perform virtual memory management operations on behalf of one or more processes executed by the CPU, illustrated in FIG. 3 as compute applications A and B. As instructions are executed by the host processor 301, virtual address translation may be performed by MMU 302 to enable read and/or write operations in virtual memory using one or more page tables. Each of compute applications A and B may be associated with a page table, such as page table A and page table B, respectively, to map virtual memory pages to physical memory pages. A page table may include a plurality of fields that provide information to enable the mapping. The SMMU 304 and/or MMU 305 may also perform virtual memory management operations on behalf of one or more processes executed by the outer domain processor 303, illustrated in FIG. 3 as compute jobs A1, A2, B, and C.

The MMU 302, the MMU 305, and the SMMU 304 may access a memory location of a shared virtual memory address space. A shared virtual memory address space may be partitioned into pages, typically contiguous blocks of virtual memory, which may serve as units of data for which memory allocation and read/write operations may be performed. In some aspects, the MMU 302, the MMU 305, and the SMMU 304 may share a page table, such as page table A, to access memory locations 306, or as another example, page table B, to access memory locations 308. Thus, a virtual address space from an application running on one processing device may be shared across other threads or kernels running on another processing device. Sharing the page table provides efficiencies over replicating a page table for each processing device.

Among other memory management functions, the shareability of virtual memory pages may be determined and changed according to the needs of processes executed in the various processing devices. In an aspect, for purposes of managing page shareability, the processing devices of a CPU (e.g., the host processor 301) may be considered an inner domain, and the processing devices of other processors (e.g., the outer domain processor 303, which may include a GPU or DSP) may be considered an outer domain. A processing device of the inner domain (e.g., the host processor 301) may be referred to as an inner domain processor, and a processing device of the outer domain (e.g., the outer domain processor 303) may be referred to as an outer domain processor. Each virtual memory page may be indicated as shareable or not shareable among the inner and outer processing domains. As one example, within the ARM instruction set architecture, shareability domains may be defined within which memory accesses may be kept consistent (i.e., predictable) and coherent. In an aspect, a virtual memory page that is marked inner shareable may be shared among multiprocessor CPUs, whereas a virtual memory page that is marked as outer shareable may be shared among CPUs and other processing devices. Therefore, within the ARM instruction set and the MMU/SMMU architecture, an existing page table format already includes a shareability attribute that may be employed in various aspects without requiring any changes or additions to the page table format and without requiring separate copies of the page table. As one example, the ARM Outer Shareable attribute of a page table may be used in various aspects. However, the various aspects are not limited to either the ARM Outer Shareable attribute or ARM architecture systems, and various aspects may be employed in other architectures that provide a suitable attribute in the page table.

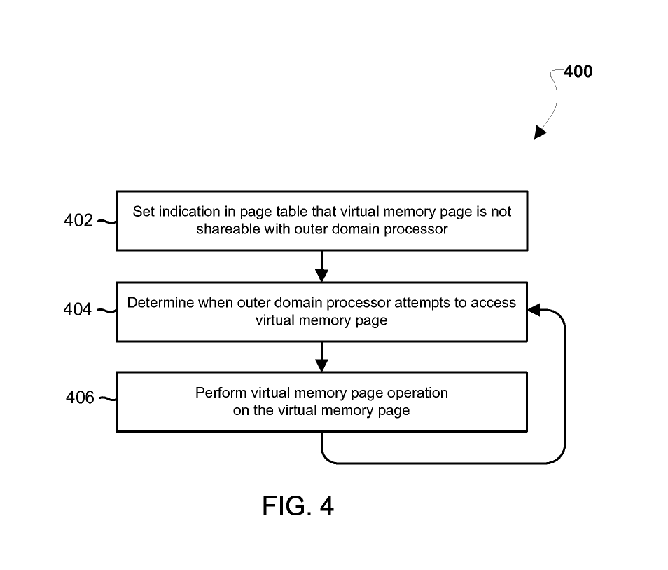

FIG. 4 is a process flow diagram illustrating an aspect method 400 that may be executed by a processor or memory management unit to improve the functioning of a computing device by better managing virtual memory page shareability. In block 402, a processor or memory management unit more set an indication in a page table, such as page table A, that a virtual memory page is not shareable with an outer domain processor. It typically is impossible to determine in advance whether data will be shared with more than one processor at the time that memory is allocated to a thread or kernel. However, setting all potentially shareable virtual memory pages (as one example, user application memory pages) as sharable with outer domain processors for heterogeneous computing may increase the overhead associated with the messaging and processing operations needed to maintain memory coherency. In an aspect, the indication may be set using existing bits of a field in the page table, without using any additional information, such as additional metadata or an additional data structure. The indication may be set in the page table by, for example, the host processor 301, the MMU 302, the outer domain processor 303, the outer domain processor MMU 305, the SMMU 304, or another similar device or function.

As one example, in block 402 a processor or memory management unit may initially mark substantially all application pages (i.e., associated with a shareability indication) as “inner shareable, not outer shareable”—that is, as shareable among processing devices of the inner shareable domain (inner shareable) and not shareable among processors of the outer shareable domain (not outer shareable). Providing the shareability indications in page table fields that are consistent with current architecture standards allows the maintenance of a page table that is consistent with existing standard memory architecture. More specifically, in an aspect, existing bits in the page table that indicate inner shareable and outer shareable may be used to represent CPU-shared-only and heterogeneous shared regions (i.e., shareable with an outer domain processing device). By using existing page table fields, additional fields are rendered unnecessary, and moreover, no additional metadata or data structures are required to indicate shareability of a virtual memory page. Further, generating the interrupt by the MMU or SMMU when the page access is attempted represents an extension of current memory management unit architecture.

In block 404, a processor or memory management unit (e.g., the processor 303, the MMU 305, or the SMMU 304) may detect an attempt or request from an outer domain processor to access the virtual memory page that is indicated as not shareable with the outer domain processor. In an aspect, an attempt or request to access the virtual memory page from a non-CPU processing device may be detected by the MMU 305 or the SMMU 304. As an example, an outer domain processor may execute a job or other process that requires access to a virtual memory page, and when the outer domain processor attempts to read the virtual memory page, the MMU 305 or the SMMU 304 may detect that the requested virtual memory page is marked with the indication that it is not shareable with the outer domain processor.

In block 406, a processor or memory management unit may perform a virtual memory page operation on the virtual memory page based on the determination. In an aspect, the virtual memory page operation performed by a processor or memory management unit may include changing the page table indication to share the virtual memory page with the outer domain processor, which may include changing a least one existing bit in the page table field of the page table to indicate that the virtual memory page is shareable with the outer domain processor. Alternatively or additionally, the virtual memory page operation performed by a processor or memory management unit may include determining an access permission for the virtual memory page to indicate whether the outer domain processor may access the virtual memory page. In alternative or additional aspects, based on the attempted access to the virtual memory page, debugging information may be generated for the virtual memory page. Additionally or alternatively, a management operation may be performed by a processor or memory management unit for the virtual memory page based on the attempted access to the virtual memory page. Examples of a management operation for the virtual memory page include determining whether to pin the virtual memory page, and determining whether to move the virtual memory page to a memory location of a different access rate. After a processor or memory management unit performs the virtual memory page operation, the processor or memory management unit monitor for another attempt to access the virtual memory page in block 404.

In some aspects, existing bits of a page table field of the page table may be changed to indicate that the virtual memory page is shareable, or not shareable, with the outer domain processor. Using an existing data structure of a shared page table may be substantially faster than communicating with a software process, using additional metadata, or using an additional data structure to indicate the shareability of the virtual memory page. Thus, avoiding the use of additional metadata or an additional data structure provides greater computing device efficiency and speed in managing page shareability.

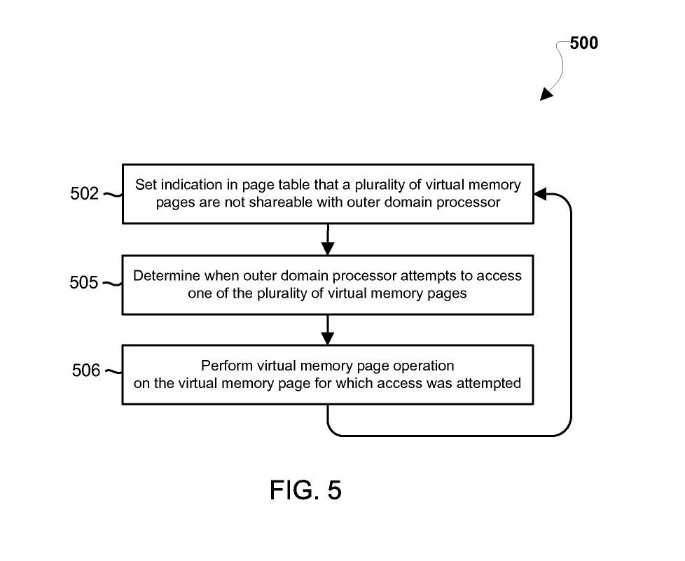

FIG. 5 is a process flow diagram illustrating another aspect method 500 that may be executed by a processor or memory management unit to improve the functioning of a computing device by better managing virtual memory page shareability. In block 502, a processor or memory management unit may set an indication in a page table to indicate that a plurality of virtual memory pages are not shareable with an outer domain processor. For example, substantially all virtual memory pages that are potentially shareable may be initially marked by a processor or memory management unit as not shareable with an outer domain processor. In operation, certain virtual memory pages may never be shared with another processing device, such as a CPU or GPU buffer, or other dedicated memory space allocated to a processing device. Thus, in an aspect, a processor or memory management unit may initially indicate that the potentially shareable virtual memory pages are not shareable with an outer domain processor. In an aspect, a processor or memory management unit may set the indication using existing bits of a field in the page table, without using any additional information, such as additional metadata or an additional data structure.

In block 504, a processor or memory management unit may determine when there is an attempt or request by an outer domain processor to access a virtual memory page among the plurality of virtual memory pages that are indicated as not shareable with the outer domain processor. In an aspect, the MMU 305 or the SMMU 304 may be configured to detect that the requested virtual memory page is marked with the indication that it is not shareable with the outer domain processor.

In block 506, a processor or memory management unit may perform a virtual memory page operation on the virtual memory page based on the determination. In an aspect, the virtual memory page operation performed by a processor or memory management unit may include changing the page table indication to share the virtual memory page with the outer domain processor, determining an access permission for the virtual memory page to indicate whether the outer domain processor may access the virtual memory page, generating debugging information for the virtual memory page, and performing a management operation for the virtual memory page based on the attempted access to the virtual memory page. After performing the virtual memory page operation, a processor or memory management unit may monitor for another attempt to access the same, or another, virtual memory page in block 504.

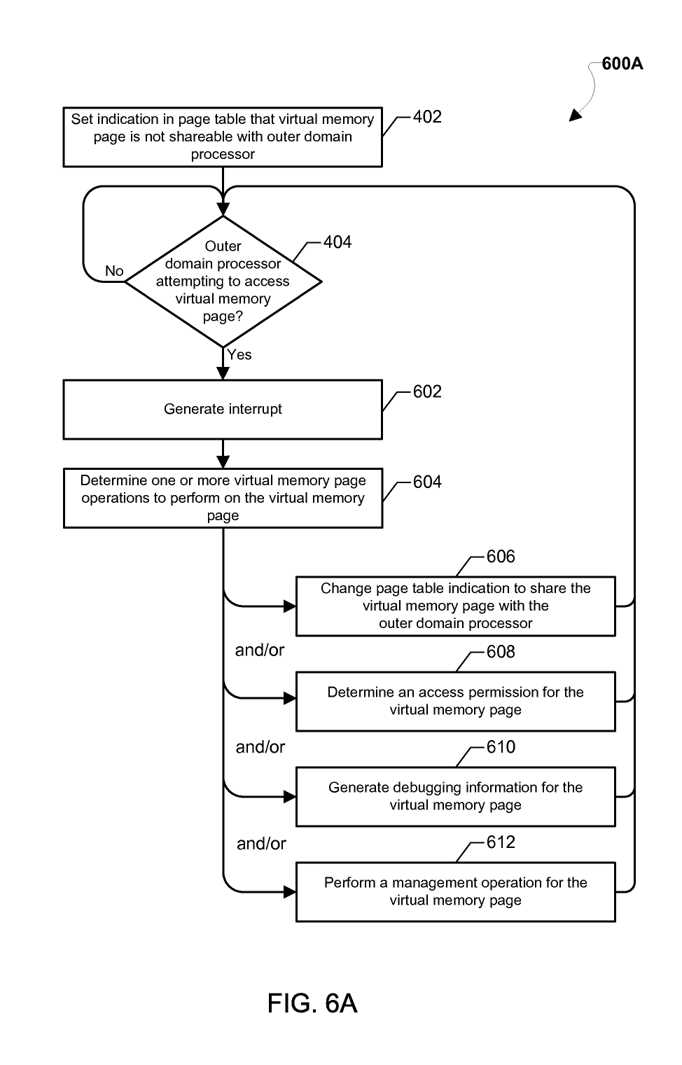

FIG. 6A is a process flow diagram illustrating another aspect method 600A that may be performed by a processor or memory management unit for managing virtual memory page shareability. Similar to method 400 described above, in block 402, a processor or memory management unit may set an indication in a page table, such as page table A, that a virtual memory page is not shareable with an outer domain processor. In an aspect, a processor or memory management unit may set the indication using existing bits of a field in the page table without using any additional information, such as additional metadata or an additional data structure. The indication may be set in the page table by the host processor 301, the MMU 302, the outer domain processor MMU 305, the SMMU 304, or another similar function, for example.

In determination block 404, a processor or memory management unit (e.g., the processor 303, the MMU 305, or the SMMU 304) may determine whether an outer domain processor attempts to access the virtual memory page that is indicated as not shareable with the outer domain processor. The monitoring in determination block 404 may be performed continuously or periodically until an outer domain processor attempts to access the virtual memory page (i.e., as long as determination block 404=“No”).

In response to determining that an outer domain processor has made an attempt or request to access the virtual memory page (i.e., determination block 404=“Yes”) a processor or memory management unit may generate an interrupt in block 602. For example, when the outer domain processor may execute a process that attempts to access the virtual memory page, the MMU or SMMU may detect the indication that virtual memory page is not shareable with outer domain processor, and generate an interrupt to stop or pause the process executed by the outer domain processor. In an aspect, the MMU or the SMMU may detect the existing bits set in the page table field of the page table that indicates that the virtual memory page is not shareable with the outer domain processor, and may generate the interrupt based on the detection of the bit pattern in the page table. Generating the interrupt by the MMU or SMMU when the page access is attempted by the outer domain processor may be consistent with current memory management unit architecture. In an aspect, a programmable register may be used to enable or disable the interrupt. The interrupt may be a fault, which may be reported in a fault syndrome register of the SMMU or the MMU.

In block 604, a processor or memory management unit may determine one or more virtual memory page operations to perform for the requested virtual memory page in response to the access attempt by the outer domain processor. For example, upon generation of the interrupt by the MMU or the SMMU, an interrupt handler may receive the interrupt generated by the MMU or the SMMU, and the interrupt handler may determine that it should perform one or more virtual memory page operations (described with reference to blocks 606-612) for the requested virtual memory page.

In an aspect, in block 604, a processor or memory management unit may determine that it should change the page table indication to share the virtual memory page with the outer domain processor in block 606. In some aspects, changing the page table indication may include may include changing a least one existing bit in the page table field of the page table to indicate that the virtual memory page is shareable with the outer domain processor.

Additionally or alternatively, in block 604, a processor or memory management unit may determine that it should determine an access permission for the virtual memory page in block 608 to indicate whether the outer domain processor may access the virtual memory page. For example, the interrupt handler may enforce differentiated access permissions from the CPU. The differentiated access permissions can include determining whether the outer domain processor may be granted read-only access, read and write access, and the like, to the requested virtual memory page. In an aspect, the interrupt handler may convert the interrupt into a permissions violation, stop the process executed by the outer domain processor, or similar procedure to enforce the differentiated access permission.

Additionally or alternatively, in block 604, a processor or memory management unit may determine that it should generate debugging information for the virtual memory page in block 610. In some aspects, based on the attempted access to the virtual memory page, debugging information may be generated for the virtual memory page. For example, when the interrupt handler detects the interrupt, debugging information representative of a relationship between the process executed on the outer domain processing device and data stored on the requested virtual memory page may be generated. This information may be, for example, encoded into a pre-defined format and stored and/or output for evaluation.

Additionally or alternatively, in block 604, a processor or memory management unit may determine that it should perform a management operation for the virtual memory page based on the attempted access in block 612. Examples of a management operation for the virtual memory page include determining whether to pin the virtual memory page, and determining whether to move the virtual memory page to a memory location of a different access rate.

Additionally or alternatively, performing an operation in response to an attempt by the outer domain processor to access the virtual memory page may include triggering a page fault in response to an attempt by the outer domain processor to access the virtual memory page. In an aspect, triggering a page fault may include triggering an interrupt to the host operating system (OS) processor to handle the page fault by stalling the outer domain processor or thread trying to make the access, triggering an interrupt to the host OS processor to handle the page fault and causing the outer domain processor to switch contexts to another thread or process, and/or causing a memory management unit to generate further data responses to the outer domain processor with a specific policy. For example, the processor may stall one or more contexts, and/or the processor may switch one or more contexts.

FIG. 6B is a process flow diagram illustrating another aspect method 600B that may be performed by a processor or memory management unit for managing virtual memory page shareability. Similar to the method 400 described above, in block 402, a processor or memory management unit may set an indication in a page table, such as page table A, that a virtual memory page is not shareable with an outer domain processor. In an aspect, a processor or memory management unit may set the indication using existing bits of a field in the page table without using any additional information, such as additional metadata or an additional data structure. The indication may be set in the page table by a host processor 301, an MMU 302, the outer domain processor MMU 305, a SMMU 304, or another similar function, for example.

In determination block 404, a processor 303, MMU 305 or SMMU 304 may determine whether an outer domain processor attempts to access the virtual memory page that is indicated as not shareable with the outer domain processor. The monitoring in determination block 404 may be performed continuously or periodically until an outer domain processor attempts to access the virtual memory page (i.e., as long as determination block 404=“No”).

In response to determining that an outer domain processor has made an attempt or request to access the virtual memory page (i.e., determination block 404=“Yes”) a processor or memory management unit may trigger a page fault condition in the MMU 305, the outer domain processor 303, or the SMMU 304 in block 616.

In an aspect, in response to a page fault condition, in block 616, the MMU 305 or SMMU 304 may stall processing of the page faulting transaction (i.e., memory operation), and potentially some other transaction(s), from the outer domain processor 303. The stalling of the transaction(s) may immediately or eventually cause the outer domain processor to also stall further processing, due to increased congestion in transaction pipelines and/or queues within and between the outer domain processor 303 and the MMU 305 or SMMU 304. Once the page fault is resolved (as it may be, e.g., via the method 500 illustrated in FIG. 5 and/or the method 600A illustrated in FIG. 6A), the MMU 305 or SMMU 304 may resume transaction processing, ending the stall of the MMU 305, the SMMU 304, or the outer domain processor 303.

Additionally or alternatively, in response to a page fault condition, in block 620, the MMU 305 or the SMMU 304 may generate a further data response to the outer domain processor with a specific policy. The specific policy may include returning zero values for reads, and/or ignoring writes (also known as read-as-zero, write-ignore or RAZ/WI) for one or more contexts. Once the page fault is resolved (as it may be via the methods 500 and/or 600A), the MMU 305 or SMMU 304 may resume normal processing, returning further data responses with a specific policy.

Additionally or alternatively, in response to a page fault condition, in block 620, a portion of—or the entire—outer domain processor 303 may stall further processing of instructions. Stalling the outer domain processor may include stalling at least a portion of a thread or a process, the processing of which is causing the attempted access of the virtual memory page. Once the page fault is resolved (e.g., via the methods 500 or 600A), the outer domain processor may be programmed to resume normal processing.

Additionally or alternatively, in response to a page fault condition, in block 622, a portion of or the entire outer domain processor 303 may perform a context switch operation, which may involve switching processing to another thread or process. The context switch may allow the outer domain processor to save the context that caused the page fault and switch to executing another context which does not have a page fault. Once the page fault is resolved (e.g., via the methods 500 or 600A), the outer domain processor may restore the previously saved context and resume normal processing.

In some aspects, the method 600B may be performed independently or in conjunction with the methods 500 and/or 600A. In some aspects, the various operations illustrated in FIG. 6B may be performed independent from notifying a host operating system, whether by generating an interrupt or by another method.

In some aspects, the memory management unit may trigger an interrupt to the host OS processor to notify the host OS processor about the page fault. Notifying the host OS processor about the page fault may include notifying the host OS processor via an inter-process interrupt, which may trigger a process on the host OS processor. Notifying the host OS processor about the page fault may also include writing a memory value, which may be polled by a process on the host OS processor. Notifying the host OS processor about the page fault may also include writing a register, which may either be polled by a process or may trigger a process on the host OS processor. Other processes or mechanisms for notifying the host OS processor about the page fault are also possible, including combinations of one or more of the foregoing.

In some aspects, the memory management unit may notify the host OS processor about the page fault without triggering an interrupt. For example, the outer domain processor (and/or memory management unit) may write to a shared memory location (e.g., update a counter), which may be periodically polled or checked by the host OS processor (e.g., by a service routing of the host OS processor). Thus, the virtual memory page operation may include profiling how the frequency by which the outer domain processer attempts to access a shared memory location.

Notifying the host OS processor may trigger or cause a process on the host OS processor. The triggered process may include changing one or more attributes of a virtual page, which may include changing an indication of shareability of the virtual page. The triggered process may also include copying one or more pages to and/or from another memory, disk, or other storage. The triggered process may also include triggering a debugging action, such as launching the debugger, or invoking a debugger operation. The triggered process may also include recording a value in memory or in a register, such as for profiling purposes. Other examples are also possible, including combinations of one or more of the foregoing.

The processor or memory management may repeat these operations in a loop by monitoring for another attempt to access the virtual memory page by an outer domain processor in determination block 404.

In various aspects, existing bits of a page table field of the page table may be changed by a processor or memory management unit to indicate that the virtual memory page is shareable or not shareable with the outer domain processor. Using an existing data structure of a shared page table may be substantially faster than communicating with a software process, using additional metadata, or an additional data structure to indicate the shareability of the virtual memory page. Thus, avoiding the use of additional metadata or an additional data structure provides greater efficiency and speed in managing page shareability. Neither the operating system, nor any driver, nor any additional software, may be invoked to determine whether to change a shareability marking of a virtual memory page. In operation, when a processor or memory management unit determines that it should change a page table indication to share the virtual memory page with the outer domain processor, an operating system process may be invoked to change the indication.

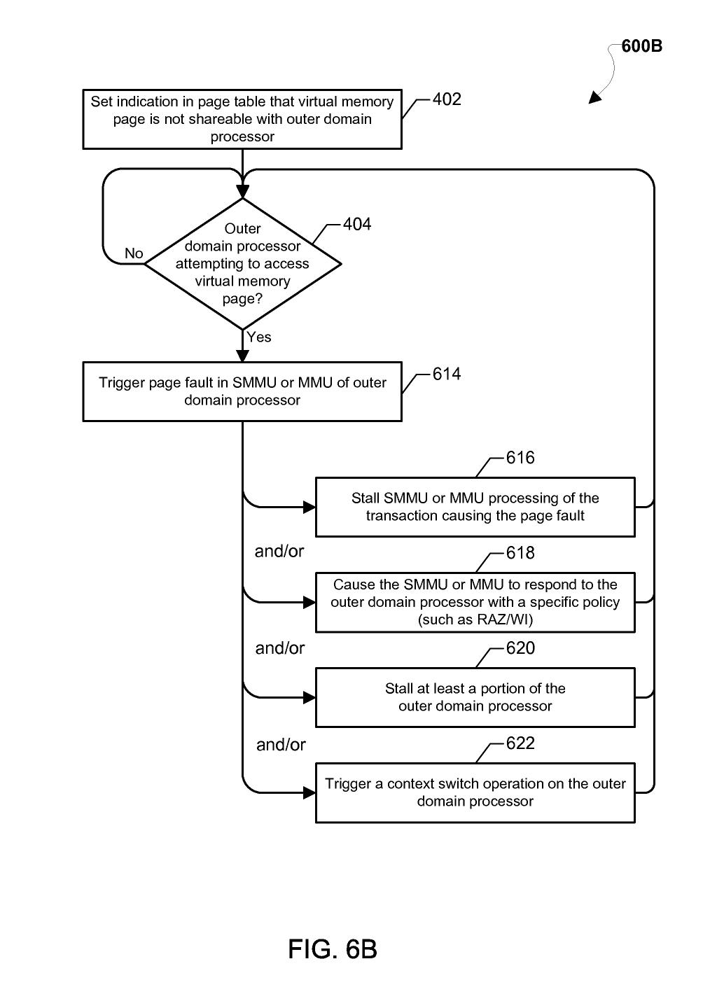

The various aspects may be implemented on a variety of mobile computing devices, an example of which is illustrated in FIG. 7. Specifically, FIG. 7 is a system block diagram of a mobile transceiver device in the form of a smartphone/cell phone 700 suitable for use with any of the aspects. The cell phone 700 may include a processor 701 coupled to internal memory 702, a display 703, and to a speaker 708. Additionally, the cell phone 700 may include an antenna 704 for sending and receiving electromagnetic radiation that may be connected to a wireless data link and/or cellular telephone transceiver 705 coupled to the processor 701. Cell phones 700 typically also include menu selection buttons or rocker switches 706 for receiving user inputs.

A typical cell phone 700 also includes a sound encoding/decoding (CODEC) circuit 713 that digitizes sound received from a microphone into data packets suitable for wireless transmission and decodes received sound data packets to generate analog signals that are provided to the speaker 708 to generate sound. Also, one or more of the processor 701, wireless transceiver 705 and CODEC 713 may include a digital signal processor (DSP) circuit (not shown separately). The cell phone 700 may further include a ZigBee transceiver (i.e., an IEEE 802.15.4 transceiver) 713 for low-power short-range communications between wireless devices, or other similar communication circuitry (e.g., circuitry implementing the Bluetooth® or WiFi protocols, etc.).

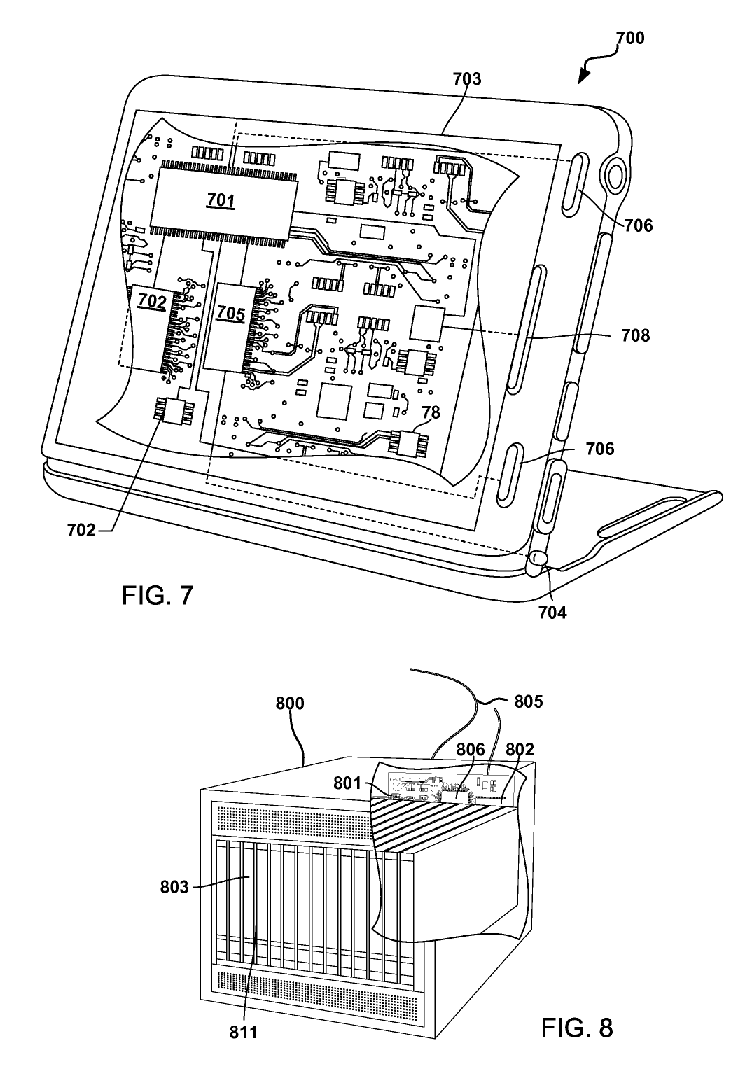

Various aspects may be implemented on any of a variety of commercially available server devices, such as the server 800 illustrated in FIG. 8. Such a server 800 typically includes a processor 801 coupled to volatile memory 802 and a large capacity nonvolatile memory, such as a disk drive 803. The server 800 may also include a floppy disc drive, compact disc (CD) or DVD disc drive 811 coupled to the processor 801. The server 800 may also include network access ports 806 coupled to the processor 801 for establishing data connections with a network 805, such as a local area network coupled to other communication system computers and servers.

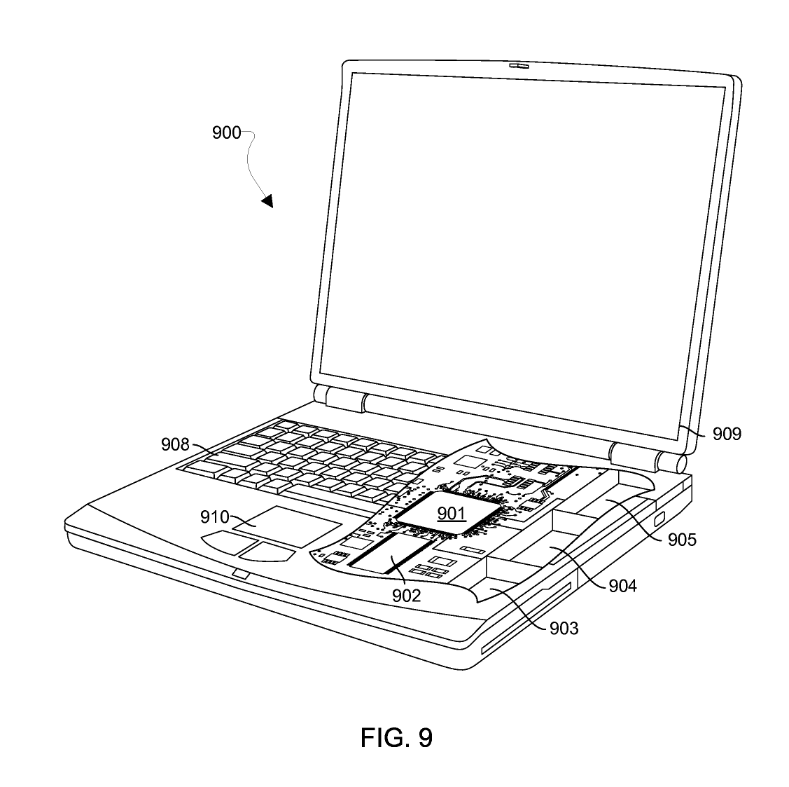

Other forms of computing devices may also benefit from the various aspects. Such computing devices typically include the components illustrated in FIG. 9, which illustrates an example personal laptop computer 900. Such a personal computer 900 generally includes a processor 901 coupled to volatile memory 902 and a large capacity nonvolatile memory, such as a disk drive 903. The computer 900 may also include a compact disc (CD) and/or DVD drive 904 coupled to the processor 901. The computer device 900 may also include a number of connector ports coupled to the processor 901 for establishing data connections or receiving external memory devices, such as a network connection circuit 905 for coupling the processor 901 to a network. The computer 900 may further be coupled to a keyboard 908, a pointing device such as a mouse 910, and a display 909 as is well known in the computer arts.

The processors 701, 801, 901 may be any programmable microprocessor, microcomputer or multiple processor chip or chips that can be configured by software instructions (applications) to perform a variety of functions, including the functions of the various aspects described below. In some mobile devices, multiple processors 701 may be provided, such as one processor dedicated to wireless communication functions and one processor dedicated to running other applications. Typically, software applications may be stored in the internal memory 702, 802, 902 before they are accessed and loaded into the processor 701, 801, 901. The processor 701, 801, 901 may include internal memory sufficient to store the application software instructions.

The various aspects may be implemented in any number of single or multiprocessor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g. program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of the various aspects must be performed in the order presented. As will be appreciated by one of skill in the art the order of blocks in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the aspects disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable storage medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method of managing virtual memory page shareability, comprising:
setting in a page table an indication that a virtual memory page is not shareable with an outer domain processor;
monitoring for an attempt by the outer domain processor to access the virtual memory page; and
performing an operation in response to an attempt by the outer domain processor to access the virtual memory page.

2. The method of claim 1, wherein performing an operation in response to an attempt by the outer domain processor to access the virtual memory page comprises performing a virtual memory page operation on the virtual memory page.

3. The method of claim 2, wherein performing a virtual memory page operation on the virtual memory page comprises changing the indication in the page table to indicate that the virtual memory page is shareable with the outer domain processor.

4. The method of claim 3, wherein:
setting in a page table an indication that a virtual memory page is not shareable with an outer domain processor comprises setting in an existing page table field of the page table the indication that the virtual memory page is not shareable with the outer domain processor; and
changing the indication in the page table to indicate that the virtual memory page is shareable with the outer domain processor comprises changing the indication in the existing page table field of the page table.

5. The method of claim 4, wherein:
setting in an existing page table field of the page table the indication that the virtual memory page is not shareable with the outer domain processor comprises setting at least one existing bit in the page table field of the page table indicating that the virtual memory page is not shareable with the outer domain processor; and
changing the indication in the existing page table field of the page table comprises changing the at least one existing bit of the page table field of the page table indicating that the virtual memory page is shareable with the outer domain processor.

6. The method of claim 3, further comprising generating an interrupt in response to an attempt by the outer domain processor to access the virtual memory page,
wherein changing the indication in the page table to indicate that the virtual memory page is shareable with the outer domain processor comprises changing the indication in the page table based on the interrupt.

7. The method of claim 2, wherein performing a virtual memory page operation on the virtual memory page comprises determining an access permission for the virtual memory page to indicate whether the outer domain processor may access the virtual memory page.

8. The method of claim 7, further comprising generating an interrupt in response to an attempt by the outer domain processor to access the virtual memory page,
wherein determining the access permission for the virtual memory page to indicate whether the outer domain processor may access the virtual memory page is based on the interrupt.

9. The method of claim 8, wherein determining the access permission for the virtual memory page further comprises at least one of converting the interrupt into a permissions violation, stopping an instruction executing on the outer domain processor, and changing the access permission of the virtual memory page.

10. The method of claim 2, wherein performing a virtual memory page operation on the virtual memory page comprises generating debugging information for the virtual memory page based on an attempted access to the virtual memory page.

11. The method of claim 2, wherein performing a virtual memory page operation on the virtual memory page comprises performing a management operation for the virtual memory page based on an attempted access to the virtual memory page.

12. The method of claim 11, wherein the management operation for the virtual memory page comprises at least one of determining whether to pin the virtual memory page, and determining whether to move the virtual memory page to a memory location of a different access rate.

13. The method of claim 1, wherein performing an operation in response to an attempt by the outer domain processor to access the virtual memory page comprises triggering a page fault in response to an attempt by the outer domain processor to access the virtual memory page.

14. The method of claim 13, wherein performing an operation in response to an attempt by the outer domain processor to access the virtual memory page comprises stalling a memory management unit from continuing to process a memory operations.

15. The method of claim 13, wherein performing an operation in response to an attempt by the outer domain processor to access the virtual memory page comprises stalling at least a portion of the outer domain processor.

16. The method of claim 13, wherein performing an operation in response to an attempt by the outer domain processor to access the virtual memory page comprises causing the outer domain processor to perform a context switch operation.

17. The method of claim 13, wherein performing an operation in response to an attempt by the outer domain processor to access the virtual memory page comprises causing a memory management unit to generate further data responses to the outer domain processor with a specific policy.

18. The method of claim 17 wherein the specific policy comprises one of returning zero values for reads, and ignoring writes.

19. The method of claim 13, further comprising notifying a host processor about the page fault.

20. The method of claim 19, wherein notifying a host processor comprises triggering an interrupt to a host OS processor.

21. The method of claim 19, wherein notifying a host processor comprises writing a value in memory.

22. The method of claim 19, wherein notifying a host processor comprises writing a value in a register.

23. A computing device, comprising:
means for setting in a page table an indication that a virtual memory page is not shareable with an outer domain processor;
means for monitoring for an attempt by the outer domain processor to access the virtual memory page; and
means for performing an operation in response to an attempt by the outer domain processor to access the virtual memory page.

24. The computing device of claim 23, wherein means for performing an operation in response to an attempt by the outer domain processor to access the virtual memory page comprises means for performing a virtual memory page operation on the virtual memory page.

25. The computing device of claim 24, wherein means for performing a virtual memory page operation on the virtual memory page comprises means for changing the indication in the page table to indicate that the virtual memory page is shareable with the outer domain processor.

26. The computing device of claim 25, wherein:
means for setting in a page table an indication that a virtual memory page is not shareable with an outer domain processor comprises means for setting in an existing page table field of the page table the indication that the virtual memory page is not shareable with the outer domain processor; and
means for changing the indication in the page table to indicate that the virtual memory page is shareable with the outer domain processor comprises means for changing the indication in the existing page table field of the page table.

27. The computing device of claim 26, wherein:
means for setting in an existing page table field of the page table the indication that the virtual memory page is not shareable with the outer domain processor comprises means for setting at least one existing bit in the page table field of the page table indicating that the virtual memory page is not shareable with the outer domain processor; and
means for changing the indication in the existing page table field of the page table comprises means for changing the at least one existing bit of the page table field of the page table indicating that the virtual memory page is shareable with the outer domain processor.

28. The computing device of claim 25, further comprising means for generating an interrupt in response to an attempt by the outer domain processor to access the virtual memory page,
wherein means for changing the indication in the page table to indicate that the virtual memory page is shareable with the outer domain processor comprises means for changing the indication in the page table based on the interrupt.

29. The computing device of claim 24, wherein means for performing a virtual memory page operation on the virtual memory page comprises means for determining an access permission for the virtual memory page to indicate whether the outer domain processor may access the virtual memory page.

30. The computing device of claim 29, further comprising means for generating an interrupt in response to an attempt by the outer domain processor to access the virtual memory page, wherein determining the access permission for the virtual memory page to indicate whether the outer domain processor may access the virtual memory page is based on the interrupt.

31. The computing device of claim 30, wherein means for determining the access permission for the virtual memory page further comprises at least one of means for converting the interrupt into a permissions violation, means for stopping an instruction executing on the outer domain processor, and means for changing the access permission of the virtual memory page.

32. The computing device of claim 24, wherein means for performing a virtual memory page operation on the virtual memory page comprises means for generating debugging information for the virtual memory page based on an attempted access to the virtual memory page.

33. The computing device of claim 24, wherein means for performing a virtual memory page operation on the virtual memory page comprises means for performing a management operation for the virtual memory page based on an attempted access to the virtual memory page.

34. The computing device of claim 33, wherein the management operation for the virtual memory page comprises at least one of determining whether to pin the virtual memory page, and determining whether to move the virtual memory page to a memory location of a different access rate.

35. The computing device of claim 23, wherein means for performing an operation in response to an attempt by the outer domain processor to access the virtual memory page comprises means for triggering a page fault in response to an attempt by the outer domain processor to access the virtual memory page.

36. The computing device of claim 35, wherein means for performing an operation in response to an attempt by the outer domain processor to access the virtual memory page comprises means for stalling a memory management unit from continuing to process a memory operation.

37. The computing device of claim 35, wherein means for performing an operation in response to an attempt by the outer domain processor to access the virtual memory page comprises means for stalling at least a portion of the outer domain processor.

38. The computing device of claim 35, wherein means for performing an operation in response to an attempt by the outer domain processor to access the virtual memory page comprises means for causing the outer domain processor to perform a context switch operation.

39. The computing device of claim 35, wherein means for performing an operation in response to an attempt by the outer domain processor to access the virtual memory page comprises means for causing a memory management unit to generate further data responses to the outer domain processor with a specific policy.

40. The computing device of claim 39 wherein the specific policy comprises one of returning zero values for reads, and ignoring writes.

41. The computing device of claim 35, further comprising means for notifying a host processor about the page fault.

42. The computing device of claim 41, wherein means for notifying a host processor comprises means for triggering an interrupt to a host OS processor.

43. The computing device of claim 41, wherein means for notifying a host processor comprises means for writing a value in memory.

44. The computing device of claim 41, wherein means for notifying a host processor comprises means for writing a value in a register.

45. A computing device, comprising:
a processor configured with processor-executable instructions to perform operations comprising:
setting in a page table an indication that a virtual memory page is not shareable with an outer domain processor;
monitoring for an attempt by the outer domain processor to access the virtual memory page; and
performing an operation in response to an attempt by the outer domain processor to access the virtual memory page.

46. The computing device of claim 45, wherein the processor is configured with processor-executable instructions to perform operations such that performing an operation in response to an attempt by the outer domain processor to access the virtual memory page comprises performing a virtual memory page operation on the virtual memory page.

47. The computing device of claim 46, wherein the processor is configured with processor-executable instructions to perform operations such that performing a virtual memory page operation on the virtual memory page comprises changing the indication in the page table to indicate that the virtual memory page is shareable with the outer domain processor.

48. The computing device of claim 47, wherein the processor is configured with processor-executable instructions to perform operations such that:
setting in a page table an indication that a virtual memory page is not shareable with an outer domain processor comprises setting in an existing page table field of the page table the indication that the virtual memory page is not shareable with the outer domain processor; and
changing the indication in the page table to indicate that the virtual memory page is shareable with the outer domain processor comprises changing the indication in the existing page table field of the page table.

49. The computing device of claim 48, wherein the processor is configured with processor-executable instructions to perform operations such that:
setting in an existing page table field of the page table the indication that the virtual memory page is not shareable with the outer domain processor comprises setting at least one existing bit in the page table field of the page table indicating that the virtual memory page is not shareable with the outer domain processor; and
changing the indication in the existing page table field of the page table comprises changing the at least one existing bit of the page table field of the page table indicating that the virtual memory page is shareable with the outer domain processor.

50. The computing device of claim 47, wherein the processor is configured with processor-executable instructions to perform operations further comprising generating an interrupt in response to an attempt by the outer domain processor to access the virtual memory page,
wherein the processor is configured with processor-executable instructions to perform operations such that changing the indication in the page table to indicate that the virtual memory page is shareable with the outer domain processor comprises changing the indication in the page table based on the interrupt.

51. The computing device of claim 46, wherein the processor is configured with processor-executable instructions to perform operations such that performing a virtual memory page operation on the virtual memory page comprises determining an access permission for the virtual memory page to indicate whether the outer domain processor may access the virtual memory page.

52. The computing device of claim 51, wherein the processor is configured with processor-executable instructions to perform operations further comprising generating an interrupt in response to an attempt by the outer domain processor to access the virtual memory page,
wherein determining the access permission for the virtual memory page to indicate whether the outer domain processor may access the virtual memory page is based on the interrupt.

53. The computing device of claim 52, wherein the processor is configured with processor-executable instructions to perform operations such that determining the access permission for the virtual memory page further comprises at least one of converting the interrupt into a permissions violation, stopping an instruction executing on the outer domain processor, and changing the access permission of the virtual memory page.

54. The computing device of claim 46, wherein the processor is configured with processor-executable instructions to perform operations such that performing a virtual memory page operation on the virtual memory page comprises generating debugging information for the virtual memory page based on an attempted access to the virtual memory page.

55. The computing device of claim 46, wherein the processor is configured with processor-executable instructions to perform operations such that performing a virtual memory page operation on the virtual memory page comprises performing a management operation for the virtual memory page based on an attempted access to the virtual memory page.

56. The computing device of claim 55, wherein the management operation for the virtual memory page comprises at least one of determining whether to pin the virtual memory page, and determining whether to move the virtual memory page to a memory location of a different access rate.

57. The computing device of claim 45, wherein the processor is configured with processor-executable instructions to perform operations such that performing an operation in response to an attempt by the outer domain processor to access the virtual memory page comprises triggering a page fault in response to an attempt by the outer domain processor to access the virtual memory page.

58. The computing device of claim 57, wherein the processor is configured with processor-executable instructions to perform operations such that performing an operation in response to an attempt by the outer domain processor to access the virtual memory page comprises stalling a memory management unit from continuing to process a memory operation.

59. The computing device of claim 57, wherein the processor is configured with processor-executable instructions to perform operations such that performing an operation in response to an attempt by the outer domain processor to access the virtual memory page comprises stalling at least a portion of the outer domain processor.

60. The computing device of claim 57, wherein the processor is configured with processor-executable instructions to perform operations such that performing an operation in response to an attempt by the outer domain processor to access the virtual memory page comprises causing the outer domain processor to perform a context switch operation.

61. The computing device of claim 57, wherein the processor is configured with processor-executable instructions to perform operations such that performing an operation in response to an attempt by the outer domain processor to access the virtual memory page comprises causing a memory management unit to generate further data responses to the outer domain processor with a specific policy.

62. The computing device of claim 61 wherein the specific policy comprises one of returning zero values for reads, and ignoring writes.

63. The computing device of claim 57, wherein the processor is configured with processor-executable instructions to perform operations further comprising notifying a host processor about the page fault.

64. The computing device of claim 63, wherein the processor is configured with processor-executable instructions to perform operations such that notifying a host processor comprises triggering an interrupt to a host OS processor.

65. The computing device of claim 63, wherein the processor is configured with processor-executable instructions to perform operations such that notifying a host processor comprises writing a value in memory.

66. The computing device of claim 63, wherein the processor is configured with processor-executable instructions to perform operations such that notifying a host processor comprises writing a value in a register.

67. A non-transitory computer-readable storage medium having stored thereon processor-executable software instructions configured to cause a processor to perform operations for managing virtual memory page shareability, the operations comprising:
setting in a page table an indication that a virtual memory page is not shareable with an outer domain processor;
monitoring for an attempt by the outer domain processor to access the virtual memory page; and
performing an operation in response to an attempt by the outer domain processor to access the virtual memory page.

68. The non-transitory computer-readable storage medium of claim 67, wherein the stored processor-executable software instructions are configured to cause a processor to perform operations such that performing an operation in response to an attempt by the outer domain processor to access the virtual memory page comprises performing a virtual memory page operation on the virtual memory page.

69. The non-transitory computer-readable storage medium of claim 68, wherein the stored processor-executable software instructions are configured to cause a processor to perform operations such that performing a virtual memory page operation on the virtual memory page comprises changing the indication in the page table to indicate that the virtual memory page is shareable with the outer domain processor.

70. The non-transitory computer-readable storage medium of claim 69, wherein the stored processor-executable software instructions are configured to cause a processor to perform operations further comprising:
setting in a page table an indication that a virtual memory page is not shareable with an outer domain processor comprises setting in an existing page table field of the page table the indication that the virtual memory page is not shareable with the outer domain processor; and
changing the indication in the page table to indicate that the virtual memory page is shareable with the outer domain processor comprises changing the indication in the existing page table field of the page table.

71. The non-transitory computer-readable storage medium of claim 70, wherein the stored processor-executable software instructions are configured to cause a processor to perform operations such that:
setting in an existing page table field of the page table the indication that the virtual memory page is not shareable with the outer domain processor comprises setting at least one existing bit in the page table field of the page table indicating that the virtual memory page is not shareable with the outer domain processor; and
changing the indication in the existing page table field of the page table comprises changing the at least one existing bit of the page table field of the page table indicating that the virtual memory page is shareable with the outer domain processor.

72. The non-transitory computer-readable storage medium of claim 69, wherein the stored processor-executable software instructions are configured to cause a processor to perform operations further comprising generating an interrupt in response to an attempt by the outer domain processor to access the virtual memory page,
wherein changing the indication in the page table to indicate that the virtual memory page is shareable with the outer domain processor comprises changing the indication in the page table based on the interrupt.

73. The non-transitory computer-readable storage medium of claim 68, wherein the stored processor-executable software instructions are configured to cause a processor to perform operations such that performing a virtual memory page operation on the virtual memory page comprises determining an access permission for the virtual memory page to indicate whether the outer domain processor may access the virtual memory page.

74. The non-transitory computer-readable storage medium of claim 73, wherein the stored processor-executable software instructions are configured to cause a processor to perform operations further comprising generating an interrupt in response to an attempt by the outer domain processor to access the virtual memory page,
wherein determining the access permission for the virtual memory page to indicate whether the outer domain processor may access the virtual memory page is based on the interrupt.

75. The non-transitory computer-readable storage medium of claim 74, wherein the stored processor-executable software instructions are configured to cause a processor to perform operations such that determining the access permission for the virtual memory page further comprises at least one of converting the interrupt into a permissions violation, stopping an instruction executing on the outer domain processor, and changing the access permission of the virtual memory page.

76. The non-transitory computer-readable storage medium of claim 68, wherein the stored processor-executable software instructions are configured to cause a processor to perform operations such that performing a virtual memory page operation on the virtual memory page comprises generating debugging information for the virtual memory page based on an attempted access to the virtual memory page.

77. The non-transitory computer-readable storage medium of claim 68, wherein the stored processor-executable software instructions are configured to cause a processor to perform operations such that performing a virtual memory page operation on the virtual memory page comprises performing a management operation for the virtual memory page based on an attempted access to the virtual memory page.

78. The non-transitory computer-readable storage medium of claim 77, wherein the stored processor-executable software instructions are configured to cause a processor to perform operations such that the management operation for the virtual memory page comprises at least one of determining whether to pin the virtual memory page, and determining whether to move the virtual memory page to a memory location of a different access rate.

79. The non-transitory computer-readable storage medium of claim 67, wherein the stored processor-executable software instructions are configured to cause a processor to perform operations such that performing an operation in response to an attempt by the outer domain processor to access the virtual memory page comprises triggering a page fault in response to an attempt by the outer domain processor to access the virtual memory page.

80. The non-transitory computer-readable storage medium of claim 79, wherein performing an operation in response to an attempt by the outer domain processor to access the virtual memory page comprises stalling a memory management unit from continuing to process a memory operation.

81. The non-transitory computer-readable storage medium of claim 79, wherein the stored processor-executable software instructions are configured to cause a processor to perform operations such that performing an operation in response to an attempt by the outer domain processor to access the virtual memory page comprises stalling at least a portion of the outer domain processor.

82. The non-transitory computer-readable storage medium of claim 79, wherein the stored processor-executable software instructions are configured to cause a processor to perform operations such that performing an operation in response to an attempt by the outer domain processor to access the virtual memory page comprises causing the outer domain processor to perform a context switch operation.

83. The non-transitory computer-readable storage medium of claim 79, wherein the stored processor-executable software instructions are configured to cause a processor to perform operations such that performing an operation in response to an attempt by the outer domain processor to access the virtual memory page comprises causing a memory management unit to generate further data responses to the outer domain processor with a specific policy.

84. The non-transitory computer-readable storage medium of claim 83 wherein the stored processor-executable software instructions are configured to cause a processor to perform operations such that the specific policy comprises one of returning zero values for reads, and ignoring writes.

85. The non-transitory computer-readable storage medium of claim 79, wherein the stored processor-executable software instructions are configured to cause a processor to perform operations further comprising notifying a host processor about the page fault.

86. The non-transitory computer-readable storage medium of claim 85, wherein the stored processor-executable software instructions are configured to cause a processor to perform operations such that notifying a host processor comprises triggering an interrupt to a host OS processor.

87. The non-transitory computer-readable storage medium of claim 85, wherein the stored processor-executable software instructions are configured to cause a processor to perform operations such that notifying a host processor comprises writing a value in memory.

88. The non-transitory computer-readable storage medium of claim 85, wherein the stored processor-executable software instructions are configured to cause a processor to perform operations such that notifying a host processor comprises writing a value in a register.
